(19) United States
(12) Patent Application Publication
(10) Pub. No.: US 2018/0101606 A1
(43) Pub. Date: Apr. 12, 2018

(54) METHOD AND SYSTEM FOR SEARCHING FOR RELEVANT ITEMS IN A COLLECTION OF DOCUMENTS GIVEN USER DEFINED DOCUMENTS

(71) Applicant: ABEL TORRES MONTOYA, Wezembeek-Oppem (BE)

(72) Inventor: ABEL TORRES MONTOYA, Wezembeek-Oppem (BE)

(21) Appl. No.: 15/287,856

(22) Filed: Oct. 7, 2016

(51) Int. Cl. G06F 17/30

(52) U.S. Cl. CPC G06F 17/30696; G06F 17/2735; G06F 17/30011; G06F 17/30675

(57) ABSTRACT

A method for performing a search, which may offer enhanced functionality in particular cases such as identifying similar or partial duplicates of a documents or identifying documents in a document cluster. The method may include accessing a hierarchical network representation of the document, assigning impact values to elements in the network, sequentially performing an activation step for each of the elements in the network starting at the lowest tier, transferring activation status up the network as elements are activated, and generating similarity rankings based on similarity scores.

### BACKGROUND

The amount of textual content that is stored in electronic form is continuously increasing. More and more users are getting access to the Internet, more and more businesses are moving their paper records to cloud storage, and more and more books and scholarly works are being digitized. With this increasing volume of textual content comes a need for ways to efficiently search this content.

Typical methods of searching large volumes of text or other data have been based around keyword searching. This generally requires the data to be in some way associated with keywords; for example, when the data is images, the images may be tagged with particular keywords. In a typical example of textual data set searching, a textual data set to be searched may be indexed. For example, a given data set may be configured to make use of a distributed file system (such as APACHE HADOOP).

The text of the indexed data may then be searched by matching a keyword against the data. The frequency with which a specific keyword appears on a page is then generally used to determine the relevance of that page to the search term. Often, different weightings may be given to matching keywords within the data set based on the section or subsection in which the keyword appears. For example, when the data set to be searched is a set of websites, additional weight may be given to a keyword found within the page title, a lesser amount of additional weight may be given to a keyword found within a page heading, and even less weight may be given to a keyword that appears in the body text of the page.

However, in general, little consideration is typically given as to the context in which a particular keyword appears. This means that particular tasks can often be difficult for keyword searching. For example, it is typically difficult to use keyword searching in order to identify similar or partial duplicates of a document. It can also be difficult to use keyword searching to identify, documents that belong to a given group of documents (i.e. to identify document clustering).

### SUMMARY

According to an exemplary embodiment, an alternative method and system for searching documents offering enhanced functionality in particular cases, such as identifying similar or partial duplicates of a documents or identifying documents in a document cluster, may be shown and described. Such a method may allow certain queries, such as queries directed at finding similar or partial duplicates of a document, and queries directed at finding documents which belong to a given group of documents, to be more efficiently processed.

Such a method may include accessing a hierarchical network, the hierarchical network representing one or more textual documents and including a plurality of elements, the plurality of elements arranged in at least a lowest hierarchical tier and a higher hierarchical tier, the elements arranged in the lowest hierarchical tier each having at least one parent, and the elements arranged in the higher hierarchical tier each having at least one child. The method may further include assigning, with a processor, a plurality of impact values to the plurality of elements, an impact value in the plurality of impact values being assigned to each element in the plurality of elements.

In a next step, the method may further include receiving, with a processor and from an interface, such as an interface associated with the processor or a remote interface, a user input requesting a search to be performed, the user input including one or more user input elements. The method may further include sequentially activating, or performing an activation step (that may or may not actually result in the element being activated) for each of the plurality of elements disposed in the lowest hierarchical tier, the step of sequentially performing an activation step for each of the plurality of elements disposed in the lowest hierarchical tier including incrementing an activation value for each element in the plurality of elements based on a comparison of the one or more user input elements and the plurality of elements disposed in the lowest hierarchical tier.

The method may further include determining when an element in the plurality of elements disposed in the lowest hierarchical tier has been fully activated, the activation of an element in the plurality of elements being an activation event. When the element in the plurality of elements disposed in the lowest hierarchical tier has been fully activated, the method may further include triggering the activated element and transferring an activation status of the activated element to a parent element of the activated element, and changing the activation status of the activated element to be inactive.

The method may further include associating each of the activation events with a timestamp, and performing a decay function, the step of performing a decay function comprising adjusting the transferred activation status of the activated element based on the timestamp of the activation event.

The method may further include tabulating results and making use of them, which may include outputting a similarity score describing the degree of similarity between the user input and the hierarchical network; and generating and reporting a list of elements in the higher hierarchical tier of the hierarchical network having the highest similarity scores. The scores produced as a result of the search may be, for example, ranked by similarity score such that elements having the highest scores for their similarity to the input query are placed higher in the list of results that are displayed to the user. In some embodiments, this may allow a user to readily identify which documents or data items exhibit the closest similarity or relevance to a document or data item used as a user input.

In some exemplary embodiments, the elements may be output on an interface of a user, such as on a display on a separate client-side computer from a computer that is performing the process; in some exemplary embodiments, this may be done in real time, such that a user can view in real time the list of elements that have, up to that point, been determined to have the highest similarity scores by the process.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 displays an exemplary embodiment of a method for searching.

FIG. 2A displays an exemplary embodiment of a hierarchical tree may be defined.

FIG. 2B displays an exemplary embodiment of a hierarchical tree may be defined.

FIG. 2C displays an exemplary embodiment of a hierarchical tree may be defined.

FIG. 3A displays an exemplary table of impact values that may be assigned to basic elements.

FIG. 3B displays an exemplary table of impact values that may be assigned to parent elements.

FIG. 3C displays an exemplary table of activation scores that may be contributed to a parent element.

FIG. 3D displays an exemplary table depicting an exemplary timeline of activation for a given hierarchical network.

FIG. 3E displays an exemplary table depicting trigger multipliers that may be applied to amplify the activation of particular inputs.

FIG. 4 depicts an exemplary process that may function as a main thread for an exemplary embodiment of a method for searching.

FIG. 5 depicts an exemplary process that may function as an event processing thread for an exemplary embodiment of a method for searching.

FIG. 6 depicts an exemplary process that may function as a metric processing thread for an exemplary embodiment of a method for searching.

FIG. 7 depicts an exemplary embodiment of a partial top-down activation process.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary embodiments of a method and system for searching for relevant items in a collection of documents, given user defined documents, may be shown and described. According to some exemplary embodiments, different user inputs regarding a document to be searched for or compared may be contemplated. For example, in an exemplary embodiment, a method for searching may take as an input a short article, and may be able to search to find textual sources that are similar to that short article or which feature that short article. In another exemplary embodiment, a method for searching may take as an input an extensive book spanning hundreds of pages, and may be able to search to find textual sources which are similar to the book or which are featured within the book.

In an exemplary embodiment, a method for searching may be configured, when comparing two extensive documents, to integrate the contributions of multiple similar fragments appearing within the documents. This may serve to limit the number of documents that are identified as being similar to one fragment appearing within a first document used to generate a search, but which are upon closer inspection not similar to other fragments appearing within the first document.

A method for searching may also be configured to, in some embodiments, take into account the relative distance of terms within the documents. If the words of a phrase found often in a first document are found less commonly in a second document, then the documents may be identified as being more dissimilar. Likewise, if particular phrases in a first document found in close connection with each other in a first document are found in a second document, but are interspersed throughout the document, the documents may be identified as being more dissimilar.

In some embodiments, a method for searching may be user-configurable. For example, in an exemplary embodiment, a user may be able to adjust, or may be able to request the adjustment of, the mechanisms that are used to compute the relevance of a particular piece of text. In other exemplary embodiments, automatic mechanisms may be used to compute the relevance of a piece of text, and may be used instead of or in conjunction with user-defined mechanisms, as may be desired.

In some exemplary embodiments, a method for searching may be applicable to documents, and may be configured to, for example, take into account conditions such as those previously mentioned in order to compute the relevance of data in a collection of documents and output a result that has been ranked by relevance. In another exemplary embodiment, such a method for searching may be generic, and may be applicable to data other than textual data in document form; for example, in some exemplary embodiments, the method may be extended to any sequences of data, or any other types of data, that may be organized in hierarchical trees.

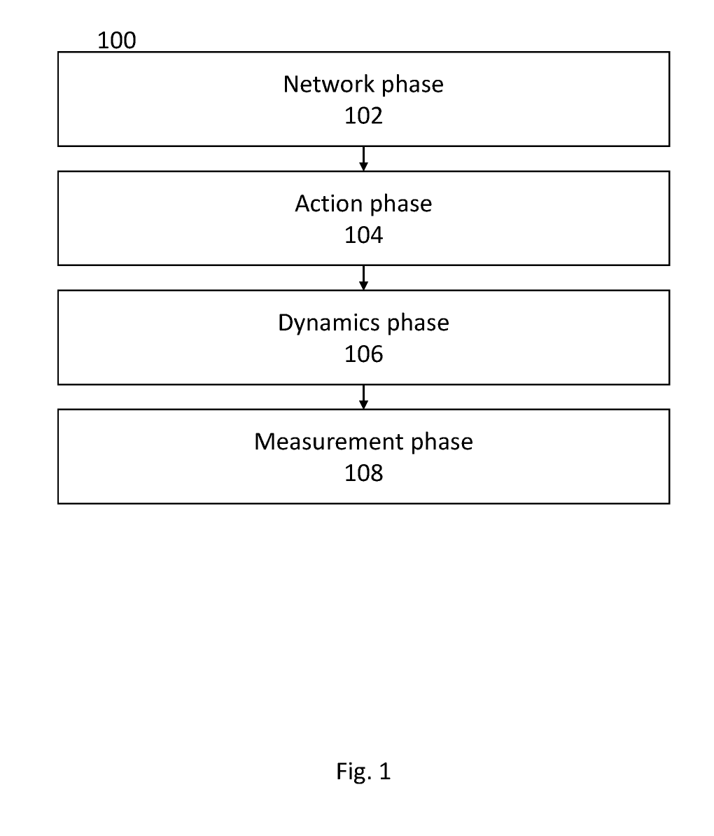

Turning now to exemplary FIG. 1, FIG. 1 displays an exemplary embodiment of a method for searching 100. In an exemplary embodiment, a method for searching 100 may function, in broad terms, similarly to a method that may be used to recall a memory during a conversation. In such a method, a speaker may bring up a particular topic that is to be recalled by the listener. While listening to the speech from the speaker (that is, while the listener is receiving user input), the listener may activate memories which contain the same or similar information to the topic the speaker is speaking about. If particular elements appearing in the speech of the speaker are present more commonly within in a memory, the listener may have a better recollection of that memory. Such memories in this example may be likened to a collection of documents in a method for searching 100. As particular elements that appear in the user input of a method for searching are found to exist more commonly in a particular document, the document may be identified as being more strongly associated with the input.

In an exemplary embodiment, a first phase of a method for searching 100 may be a network phase 102. In a network phase 102, a data set, such as a document or collection of documents stored in a database, may be represented as a hierarchical network. In an exemplary embodiment, each step of the hierarchical network may be an item of text having varying complexity; for example, words may be on a first step of the hierarchical network, phrases consisting of one or more words may be on a second step, sentences may be on a third step, and so forth. In the network phase 102, impact or relevance values may be assigned to each of the elements within the hierarchical network, which may reflect the relative importance of any one item in relation to other items within the hierarchical network.

In an exemplary embodiment, a next phase of a method for searching 100 may be an action phase 104, In an action phase, user input regarding one or more items to be searched for may be received. Following the receipt of user input, the lowermost elements of the hierarchical network, such as, for example, the word elements of the hierarchical network, may be activated.

In the action phase 104, an activation value may be generated; said activation value may be a multiplier of the user input that influences how the user input is passed to the network. For example, according to an exemplary embodiment, higher activation values may propagate further and deeper into the network.

According to an exemplary embodiment, generally, in an action phase 104, user input may be broken up according to the syntactical symbols used in the user input. These symbols may be, for example, commas, periods, new chapters, or any other such indications as may be desired. These symbols may be interpreted as marking the end of a particular context, and may regulate which hierarchical elements remain active in the hierarchical network.

In an exemplary embodiment, a next phase of a method for searching 100 may be a dynamic phase 106. In a dynamic phase 106, according to an exemplary embodiment, an activation may be propagated up, from the bottom up, into a hierarchical network. In some embodiments, such an activation may take into account attributes of the hierarchical network such as the abstraction level, or may take into account other attributes of the hierarchical network or its elements, such as the impact of particular elements or the decay of the user input. In some exemplary embodiments, the decay of the user input may be a measure of the difference between the user input, such as the original user input or a parsed user input, and an activated network element, such as a target network element. Other attributes other than, for example, abstraction level, impact, or decay may also be taken into account and may also regulate the dynamics of the activity propagation within the network.

In an exemplary embodiment, a next phase of a method for searching 100 may be a measurement phase 108. In a measurement phase 108, one or more activation metrics may be computed for one or more elements of interest.

In some exemplary embodiments, once a method for searching 100 has been triggered and has reached a measurement phase 108, several of the components of the network may have been triggered by the activation of the network. This activation may signal a degree of similarity that the network has with the input. In an exemplary embodiment, when there is determined to be enough similarity of the input with the network, one output may be provided that indicates similarity, while when there is determined to be not enough similarity of the input with the network, a different output may be provided that indicates dissimilarity. In order to make this determination, according to some exemplary embodiments, a metric may be computed based on, for example, the size of the document multiplied by the activation value, which may be called the “in/out energy correlation.”

Each of the phases previously mentioned may be discussed in greater detail. Referring back to a network phase 102, in a network phase 102, according to an exemplary embodiment, each document in a collection may be represented as a tree, wherein the content may be organized according to abstraction levels, such as words, phrases, sentences, paragraphs, and the like. In other embodiments, collections of documents that are linked together, such as a short story published chapter-by-chapter across several editions of a monthly magazine, may also be represented as a tree; alternatively, a tree may represent a section of a document, such as a single chapter of a book. It may further be appreciated that all such documents may be stored electronically in a database in a memory or storage.

In an exemplary embodiment, words may be placed at the base level of a hierarchical tree, and may be the most basic elements included in such a representation. At the topmost level of the hierarchical tree may be the document that the tree represents. Alternatively, a topmost level of a hierarchical tree may be a cluster of documents, such as works published by a particular author, or may be a collection of clusters, such as all of the works in a certain genre or all of the works in a particular library.

In an exemplary embodiment, one or more syntactical elements, such as punctuation marks (such as a space, a comma, a question mark, and the like), or any other elements which may operate to split information into associated areas of content such as the delimiters of an article or chapter, may be considered to be splitters that are between elements. In an exemplary embodiment, each non-basic element in the hierarchical tree—that is, each element more complex than a single word—may contain a sequence of elements and splitters, such as words separated by a plurality of spaces. In an exemplary embodiment, splitters may be used to define the abstraction level of a particular element; for example, in an exemplary embodiment, a sequence of words that are separated only by spaces may be defined as a phrase. The hierarchical tree may define a parent-child association between items at a higher level and items at a lower level, such as between the container (that is, a top-level element describing a sequence) and its content (such as elements in the sequence). However, no parent-child association may be created between the container and the splitters. In some embodiments, each element may have one, several, or (for the topmost element) no parents.

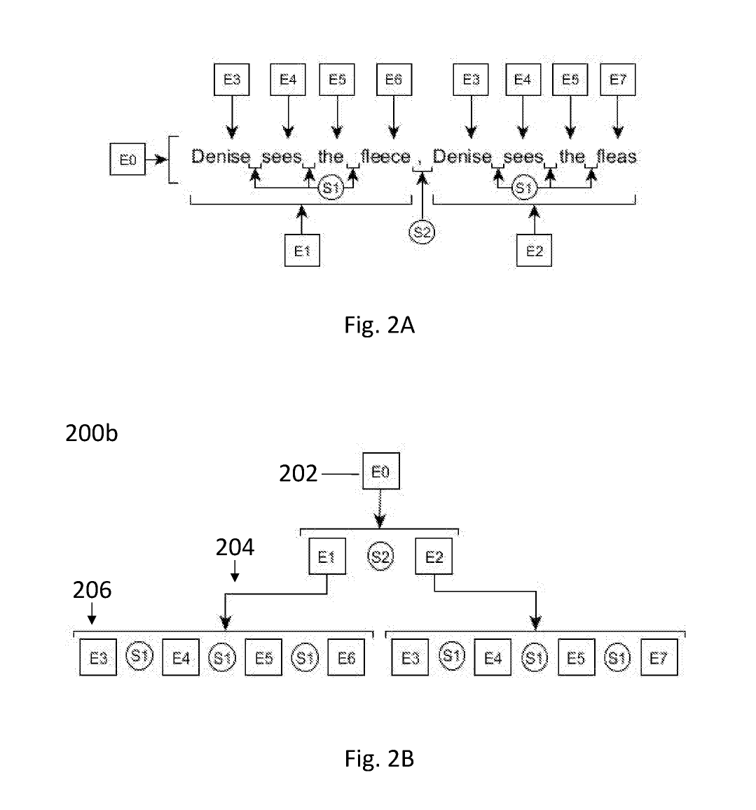

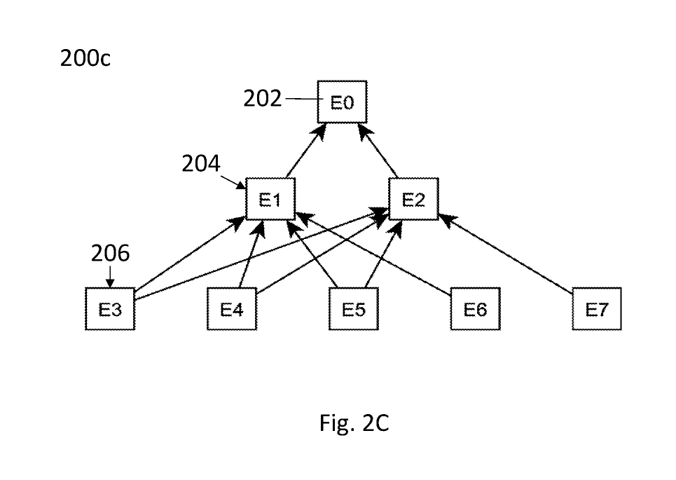

Turning now to exemplary FIGS. 2A, 2B, and 2C, FIGS. 2A, 2B, and 2C show an exemplary embodiment of how a hierarchical tree may be defined. Turning first to FIG. 2A, in an exemplary embodiment, content, such as content E0, may be broken down into a tree of abstraction levels. In an embodiment, content E0 may describe a sentence, while other elements, such as elements E1 and E2, may describe phrases within the sentence, and other elements, such as elements E3, E4, and E5 may describe words within the phrases. In an embodiment, each of the words, such as E3, E4, and E5, within the phrases, such as E1 and E2, may be separated by a splitter, such as a space S1. Each of the phrases may in turn be separated by a splitter, which may be a splitter other than a space, such as a comma S2.

As such, according to the embodiment of FIG. 2A, E0 may be defined as parent of E1 and E2, and E3, E4 and E5 may be defined as children of both E1 and E2. This relationship may be shown in exemplary FIG. 2B.

For example, in FIG. 2B, each hierarchical tier of a hierarchical tree 200b may be defined as follows. A sentence E0 or other such content may be established as a top tier 202 of a hierarchical tree 200b. The sentence E0 may have various children, each of which may be a phrase included in the sentence E0, and which may make up a second tier 204, which may include, for example, phrases E1 and E2. A splitter, such as a splitter S2, which divides phrases from one another may not be defined as an element in the second hierarchical tier 204, but may be included in the text of the sentence forming the first hierarchical tier 202.

Phrases on the second hierarchical tier 204 may then be further divided into a number of words, which may be placed at the bottom level of the hierarchical tree 206. For example, phrases E1 and E2 may be divided into, for E1, words E3, E4, E5, and E6, and, for E2, words E3, E4, E5, and E7. According to an exemplary embodiment, splitters, such as spaces S1, may be stored as part of phrases, such as phrases E1 or E2, but may not be stored as elements on the bottom level of the hierarchical tree 206.

Turning now to exemplary FIG. 2C, a hierarchical tree 200b can also be represented as a hierarchical network 200c, with elements in lower tiers being shared between elements of higher tiers instead of being duplicated between them. For example, according to the exemplary embodiment of a hierarchical network 200c shown in FIG. 2C, each of the phrase E1 and the phrase E2, each at a second tier 204, may share many of the elements on the bottom tier 206; for example, each of the phrase E1 and the phrase E2 may include element E3, element E4, and element E5. (However, only element E1 may have element E6, and only element E2 may have element E7.)

In an exemplary embodiment, each basic element, such as the words E3, E4, E5, E6, and E7 disposed on the bottom tier of the hierarchical network 206, may be associated with an impact that reflects the relative importance of the basic element. This may affect how the elements influence the search result. For example, in an exemplary embodiment, depending on the impact of a particular basic element, the element may have a higher than average or a lower than average influence on the search result. In an exemplary embodiment, this may enable a keyword search to be performed on a hierarchical tree; a keyword search may correspond to, for example, assigning an impact score of zero to all of the words except for the keywords, which may be assigned identical impact scores.

In an exemplary embodiment, when a comparison is made between two documents, it may be unknown, until the comparison is performed, which words may be present in the similar content parts. As such, an impact score may be incorporated into each of the elements so that the comparison can focus most heavily on terms that describe meaningful content when determining similarities. This may ensure that what similarities are determined relate to meaningful content, rather than being, for example, merely superficial similarities in language, if such is not desired. In keeping with this focus on meaningful content, frequently-used nonspecific terms, such as, for example, pronouns, prepositions, or determiners (e.g. words such as: a, his, its, much, my, the, that, or what), may be assigned a lower probabilistic contribution toward determining the impact of the parent than might a specific term (such as, for example, a proper noun). In some exemplary embodiments, a user may be able to configure the desired impact of frequently-used nonspecific terms or specific terms in general, or may be able to configure the desired impact of certain words upward or downward or set them to specific values (such as certain pronouns considered to be frequently-used nonspecific terms, or certain proper nouns considered to be more specific), as may be desired.

In an exemplary embodiment, terms may be assigned default values automatically, such as by a text crawler or other automated function. The assignment of default values to particular terms may be based on, for example, the frequency with which the terms appear in one or more documents, or one or more dictionary rules that have been defined for the terms. For example, in an exemplary embodiment, the following equation may be used as a guideline for assigning an element a particular impact score:

$$ElementImpact = BaseValue + \frac{ImpactWidth}{\sqrt{NumberOfParents}}$$

In the exemplary embodiment described above, the terms “BaseValue” and “ImpactWidth” may be assigned values based on the desired range of the impact scores for all of the elements, and based on the words dictionary classifications of each of the elements (for example, proper nouns, common nouns, verbs, adjectives, and the like). The two scores, taken together, may define the range of the distribution. Based on the above relation, an impact score of a particular element may be based on a flat contribution from the BaseValue term, and may be based on a variable contribution, based on how often the element appears in parent terms (for example, how often a word elements used in phrases), from the ImpactWidth term.

In some exemplary embodiments, it may be desired to search a large database with limited computer resources, and the impact thresholds may be adjusted accordingly. For example, in a large database, a user may be able to reduce the computational load of computing the contribution of frequent low impact elements by setting a minimal impact threshold, which may thereby improve the functionality of a computer performing the search and decrease the amount of time that may be required to complete a successful search. For example, according to one exemplary embodiment, once a user has set a minimal impact threshold for a database, if a particular element has a sufficiently low impact falling under a particular minimum score, its impact may effectively be set to zero and it may not be considered in calculations. In some exemplary embodiments, this minimum score may be adjustable in order to balance the performance improvements for a computer performing the search and the accuracy of the search; for example, a minimum score may be set to a very low value when accuracy is of paramount importance, or a minimum score may be set to a higher value when it is more important to improve the functionality of a computer performing the search. In an embodiment, the minimum score may also be dynamic, for example being percentile-based; for example, in an exemplary embodiment, the minimum score may be automatically adjusted so that the lowest ten percent of scores are considered to be low impact elements and so that the minimum score is higher than the lowest ten percent of scores.

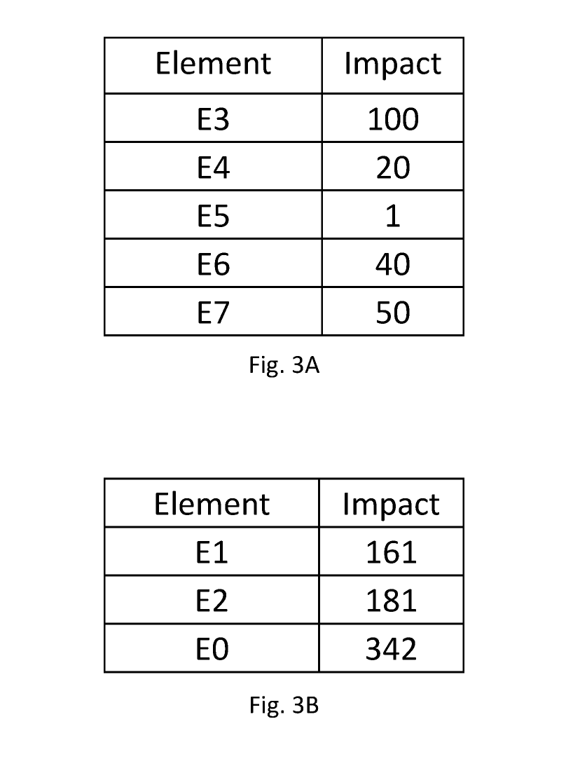

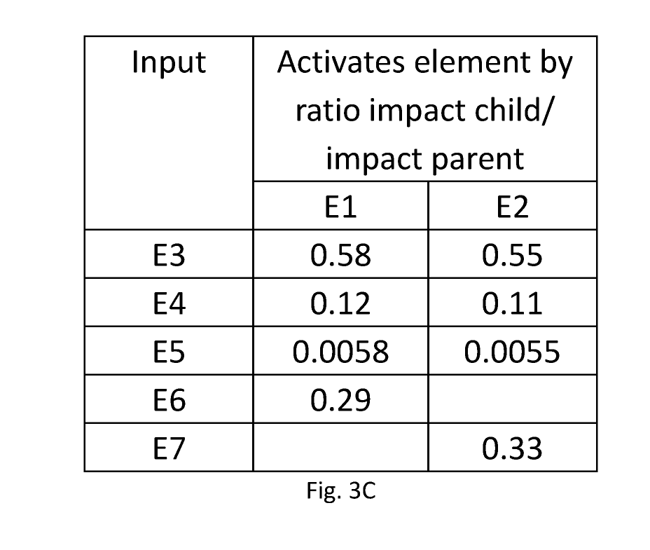

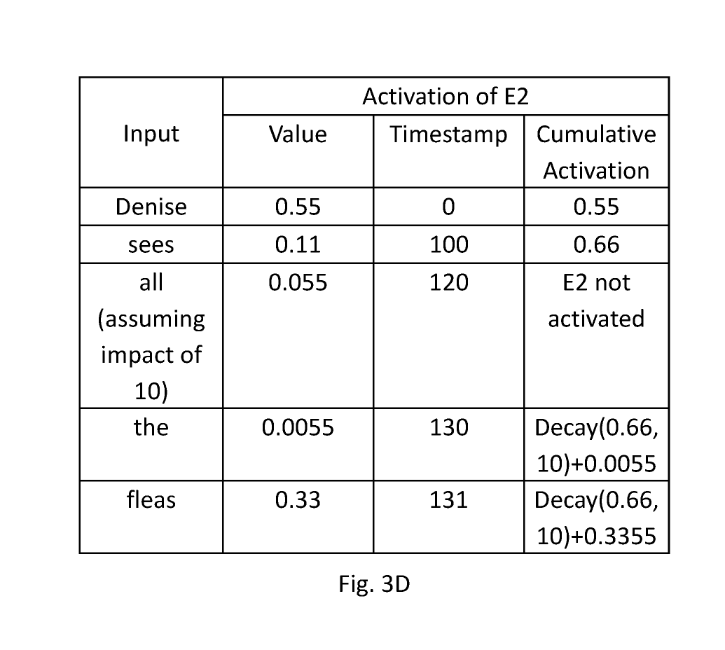

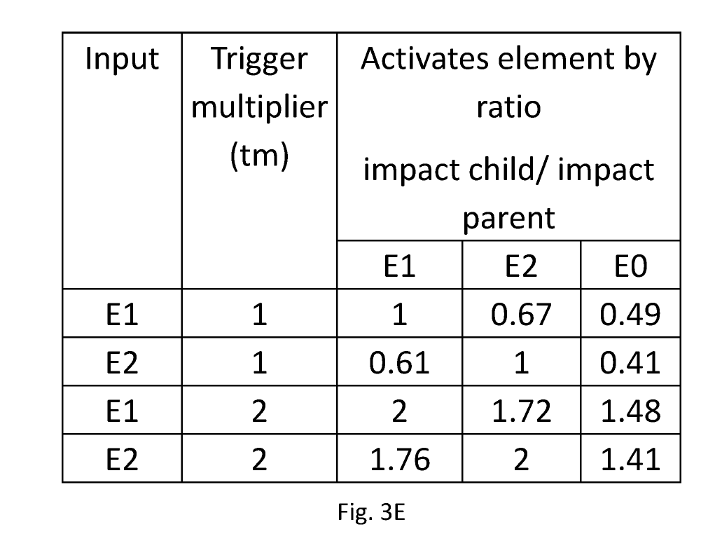

In an exemplary embodiment, the impact score for a parent element, such as for a phrase E1 or E2, may be computed as a sum of the impacts of each of the contained elements of the parent element (that is, the impacts of the child elements). FIGS. 3A and 3B show exemplary tables of values that may be used to demonstrate this.

In an exemplary embodiment, impact values may be assigned to basic elements according to the table shown in FIG. 3A. An element E3 may be assigned an impact value of 100, an element E4 may be assigned an impact value of 20, an element E5 may be assigned an impact value of 1, an element E6 may be assigned an impact value of 50, and an element E7 may be assigned an impact value of 60. In an exemplary embodiment, element E5 may be a determiner, such as “the,” explaining the low impact score. Given those impact values as shown in FIG. 3a, according to an exemplary embodiment, the calculated impact scores for each of the parent elements E1 and E2 may be, respectively, 171 and 181, as shown in FIG. 3B. The calculated impact score for the parent of those elements, E0, may be 352.

Referring back to an action phase 104, in an action phase 104, a user input may be received. In an exemplary embodiment, a plurality of documents may be received as a user input. In an embodiment, each of the user input documents may be processed in parallel and each of the network activations that may be triggered by each of the user input documents may be isolated one from another, and the results may be combined only at the metrics computation phase 108.

For each of the documents that are received as user inputs, all of the bottom elements (that is, the words) may be activated sequentially. In an exemplary embodiment, activation of an element may entail, for example, determining that the element is present in a document, or determining that the element is present some number of times in the document, or meeting another activation criterion, as desired. Once an element has been fully activated, a transfer step may be triggered, and the element may transfer its activation status to its parent element, subsequently becoming inactive. The contribution of a child to the activation status of a parent may equal the ratio of the impacts of the child element and the parent element. In an embodiment, if the child element appears more than one time in the parent element (for example, if the parent element is a phrase containing the same word multiple times), the total contribution of the child elements to the parent elements may be computed.

Turning now to exemplary FIG. 3C, FIG. 3C may show the activation scores that may be contributed to a parent element, such as a parent element E1 or E2, as a consequence of triggering specific child content. For example, according to an exemplary embodiment, triggering an input element E3 may contribute a score of 0.58 to E1, and may contribute a slightly smaller score of 0.55 to E2, based on the higher total impact score of parent element E2 (itself based on the higher impact score E7 has as compared to E6). Likewise, contributions to E1 and E2 may be made by E4 and E5, as well as E6 (to E1 only) and E7 (to E2 only).

In an exemplary embodiment, each activation event may be associated with a timestamp. Such a timestamp may be generated by, for example, determining with a timing device such as a processor clock, when an activation event has taken place. Timestamps may then be associated with particular inputs and particular activation values, such as is shown in FIG. 3D; for example, the input “Denise” may have an activation value of 0.55, and may have a timestamp of 0, indicating that the input “Denise” triggered the first activation event in its sequence. The association of activation events with timestamps may allow the construction of a timeline of activation events, which may be used to, for example, compute a decay score for the activity when the input sequence includes elements not present in the already activated element. This may mean that, in an exemplary embodiment, each successive item in the input sequence has less of an effect on the total score than it would have had had it been computed first, because of the contribution of the decay score. This also may mean that, in an exemplary embodiment, additional decay of the activation may take place when input elements are heavily spread out within a target, reducing the impact of such elements as compared to those of a document where the input elements are more closely clustered (which may, for example, provide a better indication that a document is more closely focused on a particular topic).

In an exemplary embodiment, when one element is triggered, the timeline of the activation may be increased by a function of the impact of the element. For example, in the exemplary embodiment of FIG. 3D, the time increment between elements may equal the impact of the element; for example, the impact score of “Denise” may be 100, and so forth. In an embodiment, the decay may be computed based on a half activity time formula, wherein a parameter may specify over how much time a particular activation score may be reduced to a half; for example, in an exemplary embodiment, a cumulative activation score of 0.66 may be entered into a decay function with a parameter of 10, specifying that what would otherwise be the change in the activation score may be reduced based on this half activity time parameter.

For example, according to an exemplary embodiment, the computation of a decay function may make use of the following equations. First, a new cumulative activation score may be calculated based on cumulatively summing, in a new activation score, the old activation score multiplied by a decay function (with newA starting at zero in a first case):

newA=newA+oldA×Decay

The decay score for any particular activation score (that is, any particular oldA or newA) may be computed based on the time interval between the activation score and the previous activation score (or zero, for a first case). In particular, the decay score may represent a reduction of the oldA score based on how the time interval between the activation score and the previous activation score (Δt) relates to the half activity time (HalfActivityTime) Such an equation may be as follows:

$$Decay = {( \frac{1}{2} )}^{\frac{Δ t}{HalfActivityTime}}$$

According to an exemplary embodiment, splitters in the input sequence may be used in order to take out of scope, or remove, activated elements when a higher abstraction level is started. For example, in one embodiment, a sequence of words that is separated by spaces may activate one or more parent phrases, but when a phrase splitter (such as a comma or other such punctuation) is found in the input, all currently active phrases may be removed (and a new phrase may potentially be started). Such an inhibition mechanism may be used to, for example, maintain the consistency of the hierarchical activation.

Referring back to a dynamics phase 106, in a dynamics phase 106, the input activation may be propagated up in a network of target documents; for example, in an exemplary embodiment, the input activation may be propagated up from word elements to phrase elements, and then from phrase elements to sentence elements, and so forth, continuing until the document level is reached.

According to an exemplary embodiment, and as shown in FIG. 3E, using the content of the phrase E1 as a single input may cause a trigger of E1, and a partial activation of E2 and the parent sentence E0. Likewise, the same may be true for using the content of the phrase E2 as a single input, which may cause a partial activation of E1, a trigger of E2, and a partial activation of E0. This may be shown in the first two lines of FIG. 3E, where a trigger multiplier of 1 is applied.

In an exemplary embodiment, a trigger multiplier, or “tm,” may be used to amplify the activation contribution of a particular input, which may allow the recall of higher abstraction elements from lower abstraction elements, such as the recall of documents from a word or a phrase element. Linear activation may require high values of the multiplier. In an alternative embodiment, a nonlinear adjusted formula may be used; such a formula may be based on a principle corresponding to the long-term potentiation property in neurophysiology, where multiple activations between two elements improves their connection. Likewise, then, in an exemplary embodiment, such a nonlinear adjusted formula may be constructed such that the connection between any two specific elements is stronger based on multiple activations between the elements.

For example, according to an exemplary embodiment, a nonlinear adjusted formula similar to the following may be used:

$$Eactiv = tm ( \frac{1}{1 + \frac{2 \times ( \frac{1}{activ} - 1 )}{tm \times ( tm + 1 )}} )$$

Such an equation may provide the desired nonlinear growth behavior of elements that are not used as direct inputs, as can be seen in FIG. 3E. For example, according to an exemplary embodiment, for a trigger multiplier of 1 and with E1 used as an input, the cumulative activation score corresponding to the partial activation of E2 (represented here by the term “activ”) may be 0.67. Evaluating the equation with tm=1 may yield the following:

$$Eactiv = tm ( \frac{1}{1 + \frac{2 \times ( \frac{1}{activ} - 1 )}{1 \times ( 1 + 1 )}} )$$

which may evaluate to

$$Eactiv = 1 * ( \frac{1}{1 - 1 + \frac{1}{activ}} ) = \frac{1}{( \frac{1}{activ} )} = activ$$

thus yielding a score for Eactiv that is equal to the cumulative activation score activ. However, when a trigger multiplier of 2 is used instead, the yielded Eactiv value for E2 may instead be 1.72. This means that the use of a higher trigger multiplier, such as tm=2, may provide better recall for more of the elements in the hierarchical tree, such as all three of the parent elements E1, E2, and E0 that were used in this example case.

In some exemplary embodiments, the precision of a recall may be adjusted by changing the trigger threshold (that is, a minimum threshold score for adjusted inputs, below which they will not have an effect on the activation status of a particular element) or by changing the decay coefficients. For example, in an exemplary embodiment, the similarity of the matching elements may be increased by increasing the trigger threshold, for example setting a trigger threshold of 0 closer to 1. Alternatively, or in addition to adjusting the trigger threshold, the speed of decay may be increased, for example by lowering the half activity time or making other adjustments to the decay formula. In an embodiment, when the precision has reached or exceeded a desired level, the activation may be spread through the hierarchical network by increasing the trigger multiplier.

Turning now to a measurement phase 108, following the user input, the resulting activation may be propagated up through the network. In the measurement phase 108, according to an exemplary embodiment, the activity of the elements that are of particular interest may be quantified.

In an exemplary embodiment, the metrics for the relevance of an element may depend on the goals of the user. For example, in some exemplary embodiments, it may be sufficient for the user to receive the cumulative values of the received activation.

However, in other embodiments, the user may desire to determine which documents are similar to a user input document. If the user's goal is to find related documents, this may be a more extensive task. In such an embodiment, the correlation ratio between two documents may be computed based on the following equation:

$${crDoc}_{i} = \frac{Impact ( {Doc}_{i} ) \times {outactival}_{i}}{Impact ( InputDoc ) \times tm}$$

In the above equation, according to an exemplary embodiment, Impact(InputDoc) may be or may be based on an impact score of the user input. Impact(Docᵢ)may be an impact score associated with a particular document or with a hierarchical network in a set of documents from document 1 to document i (which may of course be just one document as well as multiple documents). tm may be a trigger multiplier. outactivalᵢ may be an activation value associated with a document or with an element in a top tier of the hierarchical network, such as an element E0.

According to the above equation, the correlation ratio, crDocᵢ, may be computed for each trigger of the i documents in the collection. In some exemplary embodiments, a cumulative sum of the correlation ratios may then be computed. In some embodiments, as these computations are performed, a ranked list of the most relevant documents that have been identified up until that point may be continuously reported to the user.

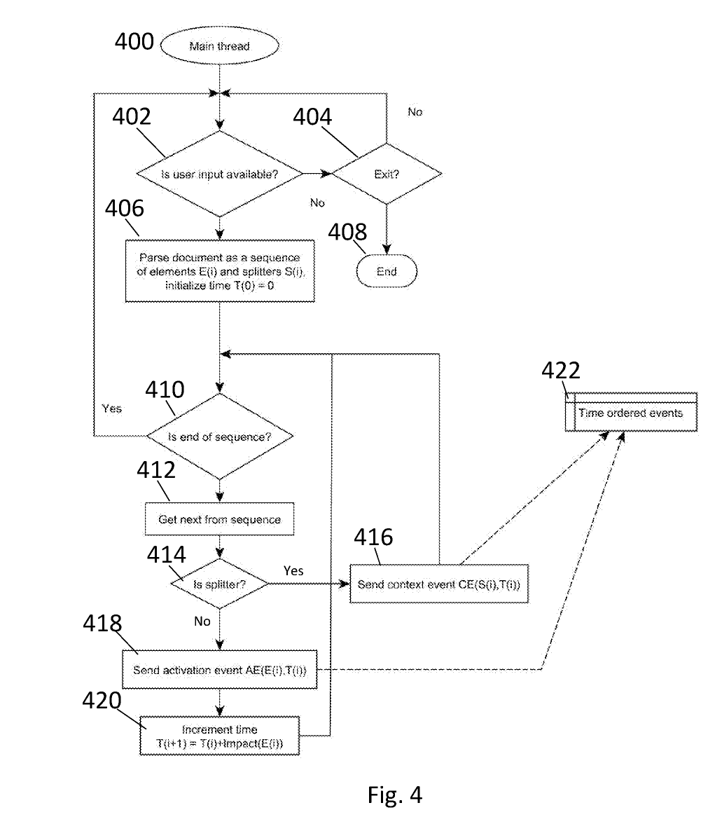

Referring now to exemplary FIGS. 4, 5, and 6, FIGS. 4, 5, and 6 may, when taken together, depict in more detail an exemplary process by which a method for searching may function. In some exemplary embodiments, the process threads 400, 500, 600 embodied in FIGS. 4, 5, and 6 may be run one after another; in other exemplary embodiments, the process threads 400, 500, 600 may be run simultaneously, or as some combination of the two.

Turning now to exemplary FIG. 4, FIG. 4 depicts an exemplary process that may function as a main thread 400 for an exemplary embodiment of a method for searching. According to an exemplary embodiment, a main thread 400 may first be initialized. A main thread 400 may then determine whether user input 402, such as user input 402 in the form of a document, is available. In the event that no user input 402 is available, the main thread 400 may be configured to exit 404, which may cause the main thread 400 to end 408. Alternatively, the main thread 400 may be configured to determine whether it should exit 404, which may optionally cause the main thread 400 to end 408 if it is determined that it should exit 404, or may cause the main thread 400 to loop to a previous point, such as a check for user input 402, if it is determined that the main thread 400 should not exit 408.

If user input 402 is available, for example in the form of a document provided to the main thread 400, the document or other user input 402 may be parsed as a sequence of elements E(i) and splitters S(i) 406. The main thread 400 may also initialize a time T(0) as equal to zero 406, or may otherwise begin tracking time starting from an initial point, as desired.

In a next step, the main thread 400 may then proceed through the sequence of elements and splitters that have been parsed 406. The main thread 400 may determine whether each parsed entry is the end of the sequence 410. If the end of the sequence has not been reached 410, the main thread 400 may proceed to a next step 412. If the end of the sequence has been reached 410, the main thread 400 may loop to a previous point, and may, for example, determine whether there is any additional user input 402 to be parsed 406 (and may, for example, exit 408 if no additional user input 402 is available to be parsed 406.

In a next step, when an element or splitter is not the end of a sequence 410, the main thread 400 may continue to the next entry in the sequence 412, which may be, for example, an element or a splitter. If the next entry in the sequence 412 is a splitter 414, then the main thread 400 may send a context event 416 CE(S(i), T(i)) to an array of time-ordered events 422. In an exemplary embodiment, this context event 416 CE may include, for example, the splitter in question (S(i)) and the time of identification (T(i)). The main thread 400 may then loop to a previous stage, and may, for example, determine whether the entry in the sequence that it has continued to 412 is the end of the sequence 410, continuing from that stage based on whether the entry is or is not the end of the sequence.

If the next entry in the sequence 412 is not a splitter 414, then the main thread 400 may determine that the next entry in the sequence 412 is an element, and may proceed accordingly. In this case, the main thread 400 may send an activation event 418 AE(E(i), T(i)) to an array of time-ordered events 422. In an exemplary embodiment, this activation event 418 AE may include, for example, the element in question (E(i)) and the time of identification (T(i)).

In a next step, a main thread 400 may increment the time 420. In an embodiment, the time may be incremented 420 only when an entry in the sequence is determined to be an element and not a splitter 414. In an embodiment, the time may be incremented 420 based on the impact value of the element, according to the relation T(i+1)=T(i)+Impact(E(i)). After incrementing the time, the main thread 400 may then loop back to a previous step; for example, in an exemplary embodiment, the main thread 400 may determine whether the element that had been read was the end of the sequence 410.

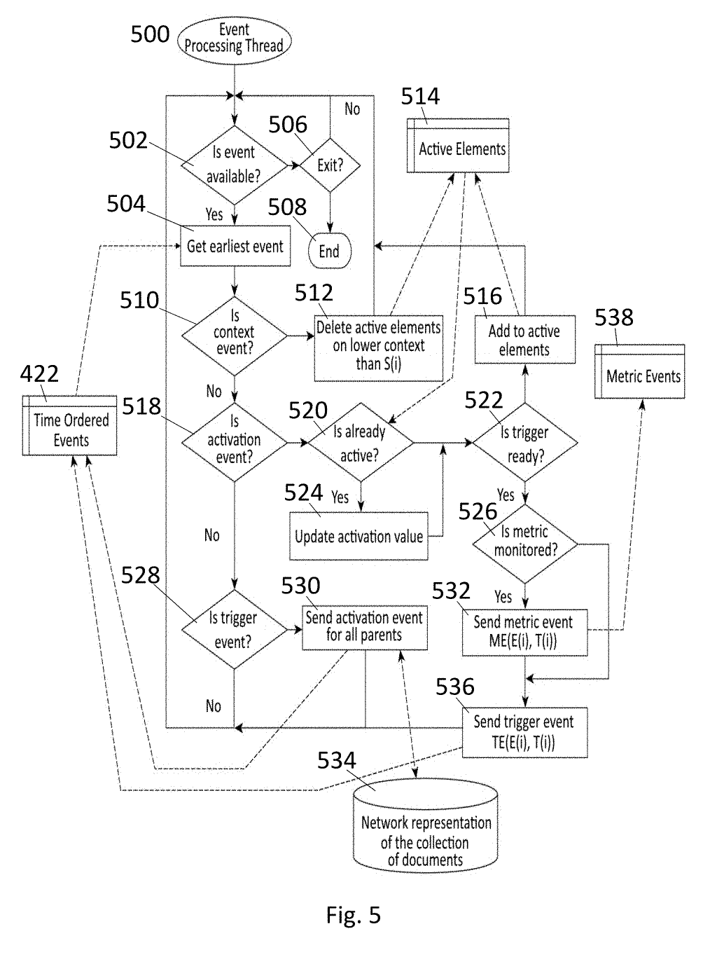

Turning now to exemplary FIG. 5, FIG. 5 depicts an exemplary process that may function as an event processing thread 500 for an exemplary embodiment of a method for searching. According to an exemplary embodiment, an event processing thread 500 may first be initialized. Upon being initialized, an event processing thread 500 may determine whether an event is available. This may be determined by, for example, accessing an array of time-ordered events 422 to determine whether there are any entries in the array of time-ordered events 422. If there are no entries in the array of time-ordered events 422, the event processing thread 500 may exit 506 or may determine whether or not to exit 506. In an exemplary embodiment, the event processing thread 500 may determine whether to exit 506, which may result in the event processing thread 500 ending 508 if the event processing thread 500 determines that it should exit 506, or may result in the event processing thread 500 looping back to an earlier step, such as a step to determine whether or not an event is available 502, if the event processing thread 500 determines that it should not exit 506.

If the event processing thread 500 determines that there are available events 502 in the array of time ordered events 422, in an exemplary embodiment, the event processing thread 500 may proceed to a next step 504, and may retrieve the earliest event in the array of time ordered events 422. The event processing thread 500 may then determine what type of event the earliest event is 510. If the event is determined to be a context event 510 (which may include, for example, a splitter S(i) and the time of identification T(i)), the event processing thread 500 may move to a next step 512, and may remove active elements that are on a lower context than S(i). This may result in a modification to the array of active events 514. The event processing thread 500 may then loop back to a previous step of the event processing thread 500, such as a step of determining whether additional events are available 502. In such an embodiment, events may be removed from the array of time ordered events 422 after being read and interpreted so that the loop may proceed through the array of time ordered events 422, as may be desired.

If the event is determined not to be a context event 510, the event processing thread 500 may then determine whether the event is an activation event 518. In some exemplary embodiments, this may be done simultaneously; for example, an event processing thread 500 may determine the type of event, and from that determination may execute a different decision based on whether the event is a context event 510 or an activation event 518, or a trigger event 528 or other type of event.

If the event is determined to be an activation event 518, the event processing thread 500 may determine whether the activation event 518 is already active 520. This may be determined by, for example, accessing an array of active elements 514 to determine whether the activation event 518 is present in the array of active elements 514. If the activation event 518 is determined to already be active 520, the event processing thread 500 may update the activation value 524, which may include, for example, applying a decay function to the activation value if it is desired to apply one. If the activation event 518 is determined not to already be active, the event processing thread 500 may then move to a next step 522, where it may determine whether or not the event trigger is ready 522.

If the event trigger is not ready 522, then the event processing thread 500 may add the activation event 516 to the list of active elements 514. In an exemplary embodiment, the added activation event 516 may use an updated activation value 524 if one has been provided, for example if the added activation event 516 was determined to already be active 520. In another exemplary embodiment, the baseline value of the activation event may be added 516. The event processing thread 500 may then proceed to a previous step in the event processing thread, such as the step of determining whether an event is available 502 in a list of time ordered events 422.

If the event trigger is determined to be ready 522, then the event processing thread 500 may determine whether or not the event trigger is associated with a monitored metric 526 or not. If the event trigger is associated with a monitored metric 526, then, according to an exemplary embodiment, a metric event ME(E(i),T(i)) may be sent 532, which may include an element E(i) and a time T(i). This sent metric event 532 may then be stored in an array of metric events 538.

If the event trigger is not associated with a monitored metric 526, or if the monitored metric has been sent in the form of a metric event 532 to an array of metric events 538, the event processing thread 500 may proceed to a next step 536, and may send a trigger event 536 to an array of time ordered events 422; a trigger event TE(E(i),T(i)) may include an element E(i) and a time T(i). Once a trigger event has been sent 536, an event processing thread may loop back to a previous step, such as, for example, a step of determining whether or not an event is available 502 in an array of time-ordered events 422, which may now include, for example, the trigger event that has just been sent 536 to the array of time-ordered events 422.

If the event is determined not to be a context event 510 or an activation event 518, in an exemplary embodiment, the event processing thread 500 may proceed to a final determination step, where the event processing thread 500 may determine whether or not the event is a trigger event 528. If the event is determined to be a trigger event 528, then the event processing thread 500 may perform an element-triggering behavior, and may sent an activation event 530 for all of the parent elements of the element that had been triggered (and for which a trigger event was sent 536). This may involve, for example, accessing a network representation of a document or of a collection of documents 534, so that the parent elements of the element that had been triggered may be properly sent activation events 530. In an exemplary embodiment, this may also result in updating of the array of time ordered events 422, such that the trigger event resulting in the activation of the parent elements 530 may be recorded in the array of time ordered events 422, for example to remove the trigger event.

In a final step, once the event has been concluded not to be a context event 510, an activation event 518, or a trigger event 528, or when the event has been determined to be a trigger event 528 and after an activation event is sent to all parents, the event processing thread 500 may loop to a previous step, for example a step of determining whether other events are available 502 in the array of time-ordered events 422. The event processing thread 500 may then repeat until terminated 508.

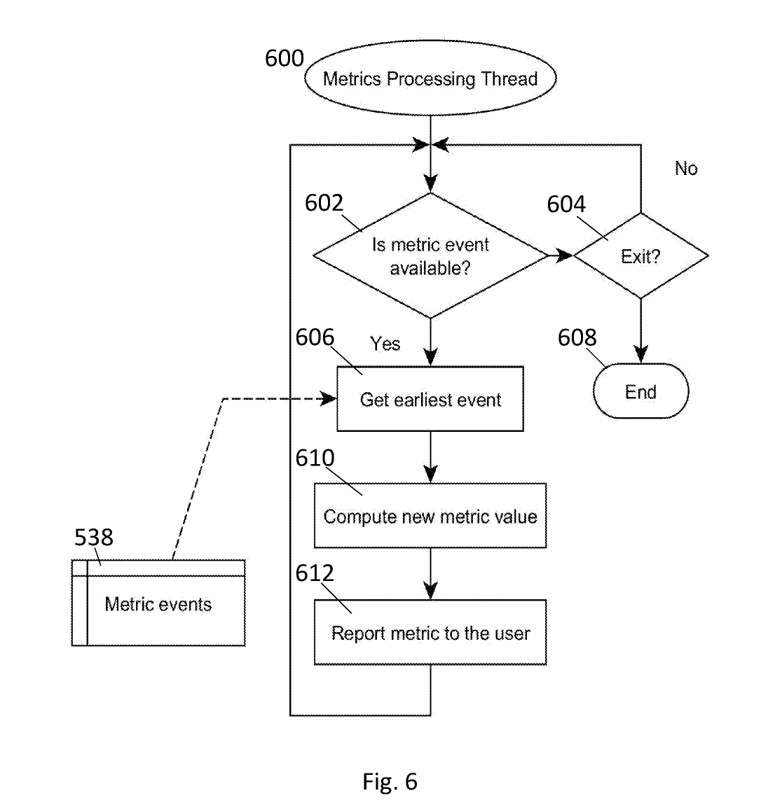

Turning now to exemplary FIG. 6, FIG. 6 depicts an exemplary process that may function as a metric processing thread 600 for an exemplary embodiment of a method for searching. In an exemplary embodiment, a metric processing thread 600 may first be initialized. A metric processing thread 600 may then determine whether there is a metric event available 602, for example by accessing an array of metric events 538 to determine whether there are any entries in the array of metric events 538. If there are no entries in the array of metric events 538, the metric processing thread 600 may exit 604 or may determine whether or not to exit 604. In an exemplary embodiment, the metric processing thread 600 may determine whether to exit 604, which may result in the metric processing thread 600 ending 608 if the metric processing thread 600 determines that it should exit 604, or may result in the event processing thread 600 looping back to an earlier step, such as a step to determine whether or not a metric event is available 602, if the metric processing thread 600 determines that it should not exit 604.

If one or more metric events is available 602 in the array of metric events 538, the metric processing thread 600 may access the earliest event 604 in the array of metric events 538. The metric processing thread 600 may then compute a new metric value 610 based on the array of metric events 538. This metric value, after being computed 610 by the metric processing thread 600, may be reported to a user 612, such as via a user interface. This may allow a list of items having the highest metric values to be dynamically maintained for a user, such that items that are determined during the course of a search to have a higher computed metric value 610 than the highest known metric values are continuously determined and reported to the user 612. Alternatively, or in addition, items that are determined during the course of a search to have a higher computed metric value 610 than a particular metric value threshold score may be continuously determined and reported to the user 612. Other configurations may also be contemplated; for example, a particular search may be configured to run as a background process and as such metric values may not be continuously reported 612 to the user, but compiled for later reporting to the user in the aggregate.

Again referring generally to the Figures, according to an exemplary embodiment, a correlation between a user input and a parent element can be computed at other than the document level. In some exemplary embodiments, different abstraction levels may be contemplated. For example, it may be desired to determine the correlation that an input may have with elements of interest such as, for example, a list of phrases occurring somewhere within the document (for example, a block quote), or one or more cities that are of interest, or elements that are relevant to a particular technology. In each of these and in other cases, according to an exemplary embodiment, relevance may be computed and monitored independently, in parallel with other relevance computations, such as a document comparison. Because of how a method for searching may be configured, in many exemplary embodiments, this may cause minimal additional load.

In some exemplary embodiments, a method for searching may also make use of a thesaurus, or a dictionary of synonyms. This may allow the method for searching to be used to not only find content that exactly matches other content but content that is similar in meaning to other content. In other exemplary embodiments, the method of matching word elements or other elements that is used by a method for searching may consider partial matches between elements, or may add to the activation score based on elements that are spelled very similarly (for example, word elements that use the same root word but which are differently conjugated). For example, in an exemplary embodiment, a document containing the phrase “Denise is seeing the fleas” may be examined using the user input “Denise sees the fleas.” In some exemplary embodiments, the word element “seeing” may be wholly or partially activated based on the user input word element “sees.”

In some exemplary embodiments, it may be desired to find content in a document that is not directly related to the user input content and which does not contain some or all of the user input elements, but which may be indirectly or more loosely related to the user input elements. In such an embodiment, a partial top down activation approach can be utilized. In such an embodiment, the activation pattern may be propagated not only up, but also horizontally to elements at the same level as the input pattern. This may allow elements that do not contain the input pattern but which are associated with it based on, for example, proximity to it to be activated to some degree based on the presence of the input pattern. Such an approach is depicted in FIG. 8.

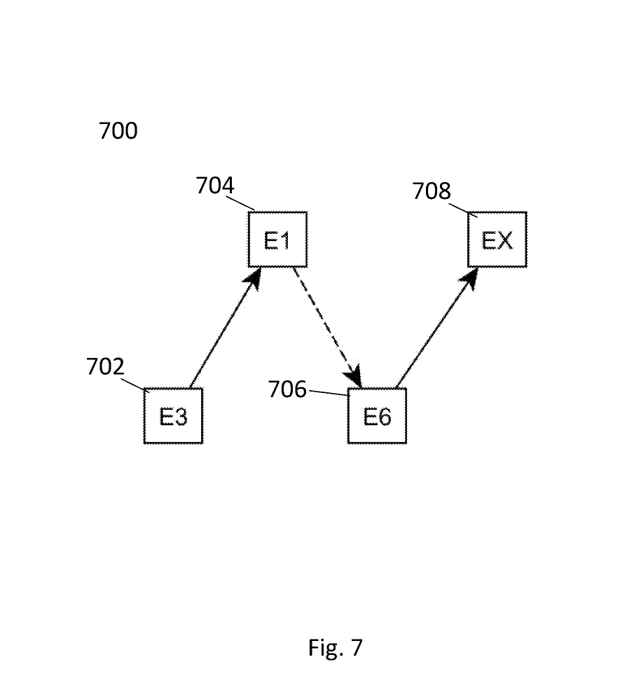

Turning now to exemplary FIG. 7, FIG. 7 depicts an exemplary embodiment of a partial top-down activation process 700. In a first step, an element at a lower level of a hierarchical tree 702, such as an element E3, may be activated. This activation may then propagate up to the parent of the element at a higher level of the hierarchical tree 704, such as a parent element E1. This may in turn trigger the element at a higher level of the hierarchical tree 704 to activate some or all of its child elements 706, such as a child element E6. In an exemplary embodiment, the activation of one or more child elements 706 by the parent element 704 may be a partial activation; that is, only a portion or fraction of the total may be passed along from the parent element 704 to the child element 706 or child elements 706.

In an exemplary embodiment, the partial activation of the one or more child elements 706 by the parent element 704 may, along with other partial activations of the child element 706, trigger the activation of the child element 706 as a result of the accumulated activation. In some embodiment, this may cause other parent elements 708 of the child element 706 to be activated, even if those other parent elements 708 do not contain the original child element 702. In other embodiments, the accumulated activation may be sufficient to partially trigger the activation of the child element 706, but one or more other steps may be necessary to trigger the activation of the child element 706 other than accumulated activation of the first child element 702; for example, it may be necessary for more than one first child element 702 to have contributed activation, if desired.

In some exemplary embodiments, a method for searching similar to that described may be applied to any type of information that may have a hierarchical representation or which may be made to conform to a hierarchical representation. This may include, for example, large datasets intended to be queried with multiple input conditions.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of performing a search, comprising:
accessing a hierarchical network, the hierarchical network comprising one or more textual documents and a plurality of elements stored in a database in a memory, the plurality of elements arranged in at least a lowest hierarchical tier and a higher hierarchical tier, the elements arranged in the lowest hierarchical tier each having at least one parent and the elements arranged in the higher hierarchical tier each having at least one child;
assigning, with a processor, a plurality of impact values to the plurality of elements, an impact value in the plurality of impact values being assigned to each element in the plurality of elements;
receiving, with a processor and from an interface, a user input requesting a search to be performed, the user input comprising one or more user input elements;
sequentially performing an activation step for each of the plurality of elements disposed in the lowest hierarchical tier, the step of sequentially performing an activation step for each of the plurality of elements disposed in the lowest hierarchical tier comprising incrementing an activation value for each element in the plurality of elements based on a comparison of the one or more user input elements and the plurality of elements disposed in the lowest hierarchical tier;
determining when an element in the plurality of elements disposed in the lowest hierarchical tier has been fully activated, the activation of an element in the plurality of elements comprising an activation event;
when the element in the plurality of elements disposed in the lowest hierarchical tier has been fully activated, triggering the activated element and transferring an activation status of the activated element to a parent element of the activated element, and changing the activation status of the activated element to be inactive;
associating each of the activation events with a timestamp, and performing a decay function, the step of performing a decay function comprising adjusting the transferred activation status of the activated element based on the timestamp of the activation event;
outputting a similarity score describing the degree of similarity between the user input and the hierarchical network; and
generating and reporting a list of elements in the higher hierarchical tier of the hierarchical network having the highest similarity scores.

2. The method of claim 1, wherein the step of generating and reporting a list of elements having the highest similarity scores further comprises continuously updating and reporting the list of elements in the higher hierarchical tier of the hierarchical network having the highest similarity scores during the performance of the search.

3. The method of claim 1, wherein the plurality of elements are arranged in a plurality of hierarchical tiers, the hierarchical tiers comprising a lowest hierarchical tier associated with word elements, a phrase hierarchical tier associated with phrase elements, a sentence hierarchical tier associated with sentence elements, and a higher hierarchical tier associated with documents;
each of the phrase elements in the phrase hierarchical tier having at least one child, the child comprising an element in the lowest hierarchical tier, and having a parent, the parent comprising an element in the sentence hierarchical tier.

4. The method of claim 3, wherein word elements in the lowest hierarchical tier are formed by separating phrase elements in the phrase hierarchical tier at word splitters, the word splitters comprising at least spaces; and
wherein phrase elements in the phrase hierarchical tier are formed by separating sentence elements in the sentence hierarchical tier at phrase splitters, the phrase splitters comprising at least punctuation marks.

5. The method of claim 1, wherein the user input comprises a document comprising a plurality of user input elements; and
wherein an impact value in the plurality of impact values is generated based on the frequency with which an element to which the impact value in the plurality of impact values is assigned appears as a user input element in the plurality of user input elements.

6. The method of claim 1, wherein an impact value in the plurality of impact values is generated based on a dictionary classification of a word element to which the impact value in the plurality of impact values is assigned.

7. The method of claim 1, further comprising defining, in a user input, a plurality of keywords; and
wherein each of the elements in the plurality of elements to which impact values are assigned is assigned an impact value of zero if the element in the plurality of elements does not match at least one of the plurality of keywords defined in the user input.

8. The method of claim 1, wherein an impact value in the plurality of impact values is generated based on the equation
$$ElementImpact = BaseValue + \frac{ImpactWidth}{\sqrt{NumberOfParents}}$$

9. The method of claim 1, wherein an element in the plurality of elements having a plurality of child elements is assigned an impact value that is the sum total of the impact values of its child elements.

10. The method of claim 1, wherein the step of performing a decay function uses the function
newA=newA+old×Decay
wherein a decay value is generated based on the function
$$Decay = {( \frac{1}{2} )}^{\frac{Δ t}{HalfActivityTime}}$$
wherein oldA is an old activation value, newA is a new activation value Δt is a time interval between an activation value and a previously-collected activation value, and HalfActivityTime is a value defining the speed of decay.

11. The method of claim 1, wherein an activation value is further adjusted using a nonlinear adjusted formula, the nonlinear adjusted formula comprising the following function:
$$Eactiv = tm ( \frac{1}{1 + \frac{2 \times ( \frac{1}{activ} - 1 )}{tm \times ( tm + 1 )}} )$$
wherein Eactiv is an adjusted cumulative activation value, activ is a non-adjusted cumulative activation value, and tm is a trigger multiplier.

12. The method of claim 1, wherein the step of outputting a similarity score describing the degree of similarity between the user input and the hierarchical network comprises generating a correlation ratio between a user input and the hierarchical network according to the function
$${crDoc}_{i} = \frac{Impact ( {Doc}_{i} ) \times {outactival}_{i}}{Impact ( InputDoc ) \times tm}$$
wherein Impact(InputDoc) is an impact score of the user input, Impact(Doc) is an impact score of the hierarchical network, tm is a trigger multiplier, and outactival is an activation value of an element in the higher hierarchical tier of the hierarchical network.

13. The method of claim 12, wherein the correlation ratio is cumulative and based on a plurality of impact scores of a plurality of hierarchical networks, and a plurality of activation values of elements in the higher hierarchical tiers of the plurality of hierarchical networks.

14. The method of claim 1, wherein the step of comparing the one or more user input elements and the plurality of elements disposed in the lowest hierarchical tier comprises:
comparing text of the user input elements and text of the plurality of elements disposed in the lowest hierarchical tier; and
comparing synonyms of the text of the user input elements and the text of the plurality of elements disposed in the lowest hierarchical tier.

15. A system for performing a search, the system comprising a processor and a memory, the memory comprising computer code executable by the processor to cause the system to carry out the following steps:
access a hierarchical network, the hierarchical network comprising one or more textual documents and comprising a plurality of elements, the plurality of elements arranged in at least a lowest hierarchical tier and a higher hierarchical tier, the elements arranged in the lowest hierarchical tier each having at least one parent and the elements arranged in the higher hierarchical tier each having at least one child;
assign, with the processor, a plurality of impact values to the plurality of elements, an impact value in the plurality of impact values being assigned to each element in the plurality of elements;
receive, with the processor and from an interface, a user input requesting a search to be performed, the user input comprising one or more user input elements;
sequentially perform, with the processor, an activation step for each of the plurality of elements disposed in the lowest hierarchical tier, the step of sequentially performing an activation step for each of the plurality of elements disposed in the lowest hierarchical tier comprising incrementing an activation value for each element in the plurality of elements based on a comparison of the one or more user input elements and the plurality of elements disposed in the lowest hierarchical tier;
determine, with the processor, when an element in the plurality of elements disposed in the lowest hierarchical tier has been fully activated, the activation of an element in the plurality of elements comprising an activation event;
when the element in the plurality of elements disposed in the lowest hierarchical tier has been fully activated, trigger the activated element and transfer an activation status of the activated element to a parent element of the activated element, and change the activation status of the activated element to be inactive;
associate, with the processor, each of the activation events with a timestamp, and perform a decay function, the step of performing a decay function comprising adjusting the transferred activation status of the activated element based on the timestamp of the activation event;
output a similarity score describing the degree of similarity between the user input and the hierarchical network; and
generate and display, on the interface, a list of elements in the higher hierarchical tier of the hierarchical network having the highest similarity scores.

16. The system of claim 15, wherein the step of generating and displaying a list of elements having the highest similarity scores further comprises continuously updating the list of elements in the higher hierarchical tier of the hierarchical network having the highest similarity scores during the performance of the search, and continuously refreshing the interface to display the updated list of elements whenever an update to the list of elements is made.

17. The system of claim 15, wherein the system is further configured to generate an impact value in the plurality of impact values based on the equation
$$ElementImpact = BaseValue + \frac{ImpactWidth}{\sqrt{NumberOfParents}}$$

18. The system of claim 5, wherein the system is further configured to perform a decay function using the function
newA=newA+oldA×Decay
wherein a decay value is generated based on the function
$$Decay = {( \frac{1}{2} )}^{\frac{Δ t}{HalfActivityTime}}$$
wherein oldA is an old activation value, newA is a new activation value, Δt is a time interval between an activation value and a previously-collected activation value, and HalfActivityTime is a value defining the speed of decay.

19. The system of claim 15, wherein the step of outputting a similarity score describing the degree of similarity between the user input and the hierarchical network comprises generating a correlation ratio between a user input and the hierarchical network according to the function
$${crDoc}_{i} = \frac{Impact ( {Doc}_{i} ) \times {outactival}_{i}}{Impact ( InputDoc ) \times tm}$$
wherein Impact(InputDoc) is an impact score of the user input, Impact(Doc) is an impact score of the hierarchical network, tm is a trigger multiplier, and outactival is an activation value of an element in the higher hierarchical tier of the hierarchical network.

20. A computer program product embodied on a non-transitory computer readable medium, comprising code executable by a computer arranged to communicate with at least one vehicle controller, to cause the computer to carry out the following steps:
accessing a hierarchical network, the hierarchical network comprising one or more textual documents and comprising a plurality of elements, the plurality of elements arranged in at least a lowest hierarchical tier and a higher hierarchical tier, the elements arranged in the lowest hierarchical tier each having at least one parent and the elements arranged in the higher hierarchical tier each having at least one child;
assigning, with a processor, a plurality of impact values to the plurality of elements, an impact value in the plurality of impact values being assigned to each element in the plurality of elements;
receiving, with a processor and from an interface, a user input requesting a search to be performed, the user input comprising one or more user input elements;
sequentially performing an activation step for each of the plurality of elements disposed in the lowest hierarchical tier, the step of sequentially performing an activation step for each of the plurality of elements disposed in the lowest hierarchical tier comprising incrementing an activation value for each element in the plurality of elements based on a comparison of the one or more user input elements and the plurality of elements disposed in the lowest hierarchical tier;
determining when an element in the plurality of elements disposed in the lowest hierarchical tier has been fully activated, the activation of an element in the plurality of elements comprising an activation event;
when the element in the plurality of elements disposed in the lowest hierarchical tier has been fully activated, triggering the activated element and transferring an activation status of the activated element to a parent element of the activated element, and changing the activation status of the activated element to be inactive;
associating each of the activation events with a timestamp, and performing a decay function, the step of performing a decay function comprising adjusting the transferred activation status of the activated element based on the timestamp of the activation event;
outputting a similarity score describing the degree of similarity between the user input and the hierarchical network; and
generating and reporting a list of elements in the higher hierarchical tier of the hierarchical network having the highest similarity scores.
